(19) United States
(12) Patent Application Publication
(10) Pub. No.: US 2022/0015983 A1
(43) Pub. Date: Jan. 20, 2022

(54) SUCTION VIBRATOR

(71) Applicant: DONGGUAN MINGYI ELECTRONIC TECHNOLOGY CO., LTD., DONGGUAN (CN)

(72) Inventor: YUNPING LI, DONGGUAN (CN)

(21) Appl. No.: 16/944,235

(22) Filed: Jul. 31, 2020

(30) Foreign Application Priority Data
Jul. 16, 2020 (CN) 202021412890.4

(51) Int. Cl. A61H 9/00; A61H 19/00; A61H 23/02

(52) U.S. Cl. CPC A61H 9/0057; A61H 19/34; A61H 2023/0227; A61H 23/0218; A61H 2009/0064; A61H 19/44

(57) ABSTRACT

A suction vibrator includes a housing including a main body vibration portion and a suction vibrating portion, a suction vibrating head including a suction bowl and a driving handle, a core tube and a coil winding. The suction bowl includes a bowl bottom and a bowl wall, both of which can form an airtight space with the skin of the massage part. The bowl wall can be elastically deformed to produce elastic force and discharge the air in the airtight space. A massage block is provided on the bowl bottom connected to the driving handle provided thereof with a permanent magnet. The coil winding is wound on the outside of the core tube and produces a magnetic field in the direction of the core tube and coil winding when the coil winding is energized, the permanent magnet in the driving handle is at least partially located in the magnetic field.

### TECHNICAL FIELD

The disclosure relates to the technical field of adult products, in particular, to a suction vibrator.

### BACKGROUND

In the current adult products, vibrators for stimulating the clitoris and other sensitive sites are common. This type of vibrators is usually used for stimulating by repetitively tapping the target sites, which is very monotonous. In addition, for current adult products, ease of use, safety and hygiene are issues that need to be prioritized. Since the products themselves will generate vibration, it will have a large adverse effect during positioning and affect the user experience.

### SUMMARY

In view of this, the object of the present disclosure is to provide a suction vibrator that can solve the above problems or at least to a certain extent.

A suction vibrator includes a housing, and the housing includes a main body vibrating portion and a suction vibrating portion. The suction vibrator also includes a suction vibrating head. The suction vibrating head includes a suction bowl and a driving handle. The suction bowl is made of an elastic material. The suction bowl includes a bowl bottom and a bowl wall. The bowl bottom and the bowl wall can form an airtight space with the skin of the massage parts.

Pressing the suction bowl on the massage part can elastically deform the bowl wall and discharge the air in the airtight space. Deformation produces elastic force. There is also a massage block on the bowl bottom. The bowl bottom may be connected to the driving handle, and a permanent magnet may be provided in the driving handle. The suction vibrator also includes a core tube and a coil winding. The coil winding may be wound on the outside of the core tube. A magnetic field along an axial direction of the core tube and the coil winding is generated, the permanent magnet is at least partially located in the magnetic field.

Further, the suction vibrating portion has an opening, the suction vibrating head passes at least partially through the opening; an outer ring of the bowl bottom is fixedly connected to the suction vibrating portion, the bowl bottom and the driving handle are connected by a connecting portion, and the connecting portion has a diameter smaller than a diameter of the opening; and a part of the bowl bottom abutting the connecting portion defines a deforming portion with the outer ring.

Further, the deforming portion is formed into a thin film shape.

Further, the deforming portion is formed in a wave shape.

Further, the diameter of the driving handle is smaller than the inner diameter of the core tube.

Further, the main body vibrating portion extends in an angle with respect of the suction vibrating portion, and the main body vibrating portion includes a vibration generator.

Further, the suction vibrator includes a control panel, a power switch, a control button and a battery, the control panel includes a control module, and the control module may be electrically connected to the power switch, the control button, the battery, the motor and the coil winding, respectively.

### BRIEF DESCRIPTION OF THE DRAWINGS

The foregoing and further features of the present disclosure will become clear from the following description of preferred embodiments provided only by way of example combining with the accompanying drawings, in which:

FIG. 1 shows a front view of the vibrator;

FIG. 2 shows a cross-sectional view of the vibrator of FIG. 1;

FIG. 3a shows a partially enlarged view of the cross-sectional view of the vibrator of FIG. 1;

FIG. 3b shows a partially enlarged view of the cross-sectional view of the vibrator of FIG. 1 when pressed on the massage part; and

FIG. 4 shows a cross-sectional view of the suction vibrating head of the vibrator of FIG. 1.

### DESCRIPTION OF THE EMBODIMENTS

In order to facilitate the understanding of the present disclosure, the following will more fully describe the suction vibrator of the present disclosure with reference to the related drawings. An example of the present disclosure is exemplarily given in the drawings to make the understanding of the technical solutions disclosed by the present disclosure more accurate and thorough. However, it should be understood that the present disclosure may be implemented in many different manners, and is not limited to the embodiments described below.

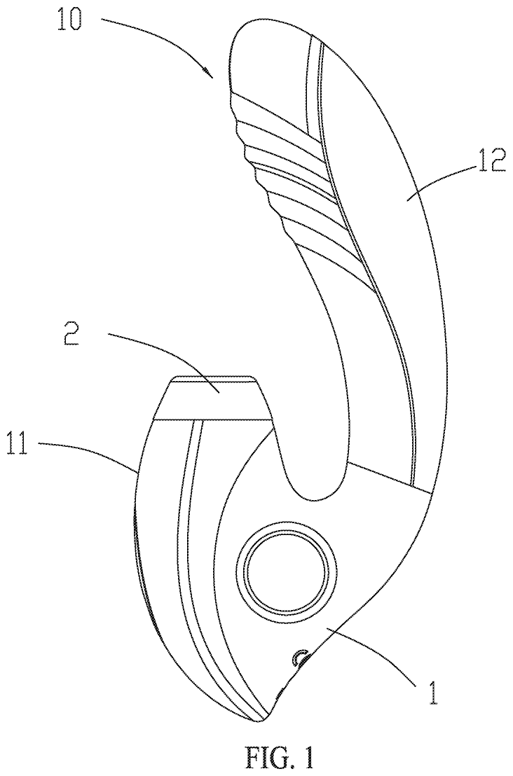

Referring to FIG. 1, a suction vibrator 10 according to one embodiment of the present disclosure may include a housing 1 that may be generally V-shaped. The housing 1 may include two generally cylindrical parts that extend at an angle with respect to each other. The extension lengths of the two parts may be inconsistent, wherein the part with the shorter extension length may be the suction vibrating portion 11, and the part with the longer extension length may be the main body vibrating portion 12.

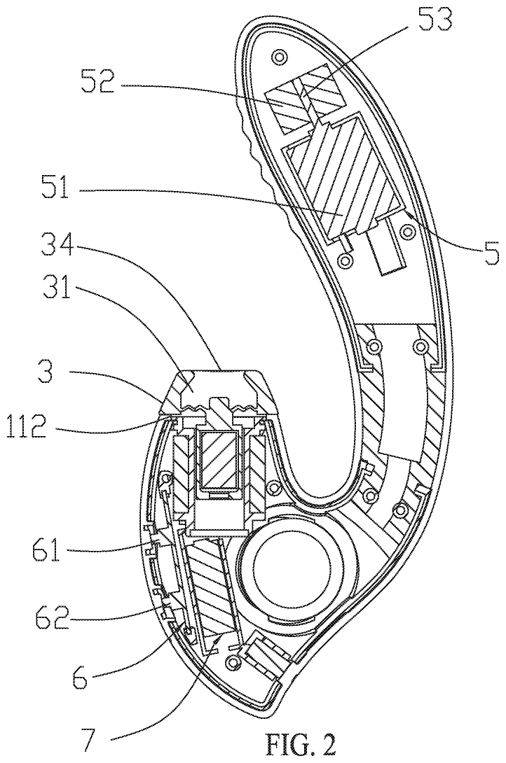

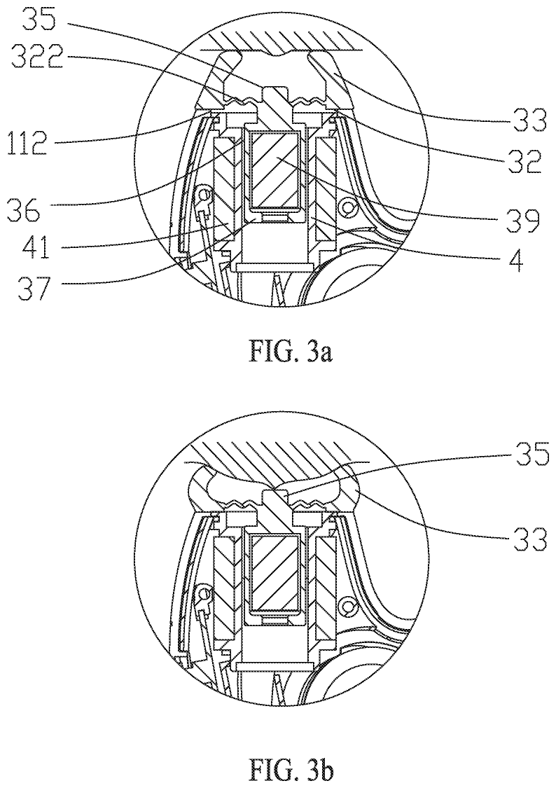

Referring to FIGS. 2 and 3a, the inside of the housing 1 may be a hollow structure. At the end of the suction vibrating portion 11 may have an opening 112 communicating with the internal cavity of the housing 1. The opening 112 may extend along the axial direction of the suction vibrating portion 11. A substantially umbrella-shaped suction vibrating head 3 made of an elastic material may be at least partially inserted into the opening 112.

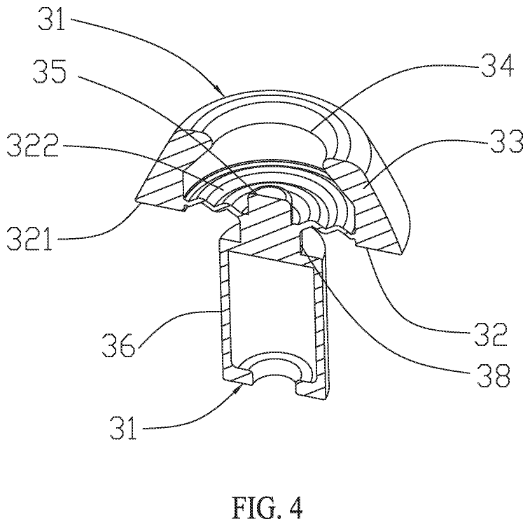

Referring to FIGS. 3a and 4, one end of the suction vibrating head 3 may include a suction bowl 31. The suction bowl 31 may be substantially bowl-shaped. The suction bowl 31 may have a disk-shaped bowl bottom 32 and a cone-shaped cylindrical bowl wall 33. One end of the cone-shaped cylindrical bowl wall 33 may be integrated with the periphery of the bowl bottom 32, and the other end may be open to define a suction bowl opening 34 that opens toward the direction away from the suction vibrating portion 11. A massage block 35 may be disposed at the center of the bowl bottom 32. The massage block 35 may be a protrusion, and the protrusion may extend toward the suction bowl opening 34. In this embodiment, the massage block 35 may be substantially cylindrical. The other end of the suction vibrating head 3 may further include a driving handle 36 including a substantially hollow cylindrical driving portion 37 that may be disposed on the side opposite to the side of the bowl opening 34 of the suction bowl 31. One end of the driving handle 36 adjacent to the suction bowl 31 may be formed as a cylindrical connecting portion 38, one end of the connecting portion 38 may be fixedly connected to the bowl bottom 32 of the suction bowl 31, and the other end of the connecting portion 38 may be connected to one end of the driving portion 37. Preferably, the driving portion 37, the connecting portion 38 and the suction bowl 31 may be integrated, and the diameter of the connecting portion 38 may be smaller than that of the driving portion 37, and the diameter of the driving portion 37 may be smaller than that of the bowl bottom 32 of the suction bowl 31. The driving handle 36 may further include a permanent magnet 39 provided inside the driving handle 36, and the directions of the two magnetic poles of the permanent magnet 39 may be parallel to the axial direction of the driving handle 36. The driving handle 36 may be adapted to at least partially extend from the opening 112 of the suction vibrating portion 11 into the suction vibrating portion 11, the diameter of the suction bowl 31 may be larger than the diameter of the opening 112, so after inserting the driving handle 36 into the opening 112 of the suction vibrating portion 11, the outer ring 321 of the bowl bottom 32 of the suction bowl 31 facing the side of the suction vibrating portion 11 can be in contact with the suction vibrating portion 11, such that the outer ring 321 of the bowl bottom 32 and the suction vibrating portion 11 can be fixed by bonding through an adhesive. The diameter of the connecting portion 38 may be smaller than that of the opening 112, such that a deforming portion 322 may be defined between the parts of the bowl bottom 32, the connecting portion 38 adjacent thereto and the outer ring 321. In addition, since the suction vibrating head 3 may be made of an elastically deformable material, the deforming portion 322 may be elastically deformable. The deforming portion 322 may be preferably formed into a thin film shape. Further preferably, the deforming portion 322 may be formed into a wave shape, thereby reducing the force required to overcome elastic deformation when the reciprocating movement of the driving portion 37 of the vibrating head 3 is operated in the axial direction.

Referring again to FIG. 2 and FIG. 3a, a core tube 4 that may be substantially hollow and cylindrical may be provided inside the suction vibrating portion 11, and the core tube 4 may be fixedly connected to the housing 1. Preferably, the axis of the core tube 4 may be substantially parallel to the axis of the suction vibrating head 3. A coil winding 41 may be provided outside the core tube 4. The coil winding 41 may be formed into a hollow cylindrical shape concentric with the core tube 4. After the coil winding 41 is energized, a magnetic field in the axial direction of the core tube 4 may be formed in the coil winding 41. The diameter of the driving portion 37 of the suction vibrating head 3 may be smaller than the inner diameter of the core tube 4, so that the driving portion 37 can be at least partially inserted into the core tube 4, and the permanent magnet 39 in the driving portion 37 may be within the action range of the magnetic field. After the coil winding 41 is energized, the magnetic field causes the permanent magnet 39 to be subjected to the magnetic field to obtain a repulsive force or a suction force along the direction of action of the magnetic field. When the magnitude and direction of the current in the coil winding 41 change, the magnitude and direction of the repulsive force or suction force applied to the permanent magnet 39 may also change accordingly.

The end of the main body vibrating portion 12 may be closed. The main body vibrating portion 12 may include a vibration generator 5 that may be fixedly installed inside the main body vibrating portion 12. In this embodiment, the vibration generator 5 may include a motor 51 and an eccentric block 52, the eccentric block 52 may be fixedly connected to the motor shaft 53 of the motor 51, and the center of gravity of the eccentric block 52 may be offset from the axis of the motor shaft 53 by a distance. When the motor shaft 53 rotates, the eccentric block 52 may rotate simultaneously, and the rotation shaft of the eccentric block 52 may deviate from the center of gravity of the eccentric block 52, thereby generating mechanical vibration. It can be understood that although the combination of the eccentric block 52 and the motor 51 is used to generate mechanical vibration in this embodiment, other known structures that can generate mechanical vibration may also be used as an alternative.

A control panel 6 may be also provided in the cavity inside the housing 1. The control panel 6 may be provided with a control module (not shown), a power switch 61 and a control button 62. The power switch 61 and the control button 62 may be electrically coupled to the control module. In addition, the control module may be electrically coupled to the battery 7 also provided in the inside cavity of the housing 1. The control module may be also electrically connected to the coil winding 41 and the motor 51 of the vibration generator 5 respectively, so that by operating the power switch 61 and the control button 62, the coil winding 41 and the motor 51 of the vibration generator 5 can be turned on or off, and the magnitude and direction of the current in the coil winding 41 and the motor 51 can be adjusted, thereby realizing various working modes.

Preferably, the main body vibrating portion 12 may be suitable for insertion into the vagina, and by setting the above-mentioned angle and the outer shape of the main body vibrating portion 12, the suction vibrating head 3 can be aligned with the clitoris when the main body vibrating portion 12 is inserted into the vagina.

In use, the main body vibrating portion 12 can be inserted into the vagina, and the suction vibrating portion 11 can be directed to the massage part such as the clitoris, or the main body vibrating portion 12 can be directly held and the suction vibrating portion 11 can be directed to the massage part. As shown in FIGS. 3a and 3b, when the suction vibrating head 3 is pressed against the massage part, the bowl wall 33 of the suction bowl 31 may be squeezed to be elastically deformed, and at the same time, the air in the suction bowl 31 may be discharged because the bowl wall 33 and the bowl bottom 32 is formed as a whole. Therefore, the inside of the suction bowl 31 and the skin of the massage part of the user jointly define an airtight space, and the stable low pressure may be generated due to the elastic deformation of the bowl wall 33, so that the suction bowl 31 may be sucked on the user's skin. Preferably, at this time, the massage block 35 on the suction bowl 31 may be aligned or in contact with the massage part such as the clitoris.

Further, when pressing the power switch 61, the control module may turn on the battery 7, and provide a constant or varying current to the motor 51 and/or the coil winding 41 in the default vibration mode, such that the main body vibrating portion 12 can generate vibration and/or can make suction vibrating head 3 produce movement. For example, by providing the coil winding 41 with a current whose direction can be rapidly switched, the driving portion 37 may get a force that changes in the direction of the axial direction, and may quickly perform a reciprocating motion, thereby driving the massage block 35 to rapidly reciprocate in the axial direction and tap the massage part. Or a sinusoidally changing current is provided to make the driving portion 37 reciprocate with a uniform speed change in a certain period along the axial direction, so that the massage block 35 can realize a gentle massage movement along the axial direction. During use, by pressing the control button 62, it is possible to switch between different vibration modes, thereby obtaining a more varied user experience.

Since the power for massage is supplied by the force of the magnetic field generated by the coil winding 41 on the permanent magnet 39 of the driving section 37, a mechanism such as a linear motor 51 with a complicated structure may be not required to supply power. In addition, since there may be a gap between the driving portion 37 and the core tube 4, and the driving handle 36 and the deforming portion 322 may be made of elastically deformable materials, while the driving portion 37 may be, thus, guided in the axial direction, and at the same time in the radial direction there may be a certain amount of movement margin, which makes the movement of the driving portion 37 more flexible, greatly reducing the failure rate of the reciprocating motion, that is, reducing the possibility that the force of the massage block 35 deviating from the axial direction and causing the driving portion 37 to be stuck in the radial direction. In addition, since the suction bowl 31 in contact with the massage part is integrally formed, its waterproofness may be also guaranteed.

After the suction vibrating head 3 is pressed against the massage part, the suction bowl 31 may be close to the skin, and the bowl wall 33 may be deformed, thereby generating a stable low pressure inside the suction bowl 31, which causes congestion and swelling of the massage part, such as the clitoris, thereby in turn making the massage part more sensitive, so as to achieve the purpose of quickly improving sexual excitement.

The disclosure has simple structure, low cost, safety and easy to use. Because the suction vibrating head 3 provides a stable and constant suction force, the user can not only obtain more intense stimulation, and it may be also easier to fix the position of the vibrator 10, to avoid distractions or troubles in cleaning due to the deviation of the position of the vibrator 10.

It should be noted that the present disclosure is not limited to the above-mentioned embodiments. According to the creative spirit of the present disclosure, those skilled in the art may make other modifications. These modifications based on the creative spirit of the present disclosure should be included within the scope claimed by the disclosure.

What is claimed is:

1. A suction vibrator comprising a housing comprising a main body vibrating portion and a suction vibrating portion, wherein, the suction vibrator further comprises:
a suction vibrating head, which comprises a suction bowl and a driving handle, the suction bowl is made of an elastic material, the suction bowl comprises a bowl bottom and a bowl wall which form an airtight space together with skin of a massage part, when the suction bowl is pressed towards the skin of the massage part, an elastic deformation of the bowl wall is created and air in the airtight space is discharged, the elastic deformation generates elastic force, and the bowl bottom is further provided with a massage block, the bowl bottom is connected with the driving handle, and the driving handle is provided with a permanent magnet; and
a core tube and a coil winding, the coil winding is wound outside the core tube, and when the coil winding is energized, a magnetic field along an axial direction of the core tube and the coil winding is generated, the permanent magnet is at least partially located in the magnetic field.

2. The suction vibrator according to claim 1, wherein the suction vibrating portion has an opening, the suction vibrating head passes at least partially through the opening, an outer ring of the bowl bottom is fixedly connected to the suction vibrating portion, the bowl bottom and the driving handle are connected by a connecting portion, and the connecting portion has a diameter smaller than a diameter of the opening, and a part of the bowl bottom abutting the connecting portion defines a deforming portion with the outer ring.

3. The suction vibrator according to claim 2, wherein the deforming portion is formed into a thin film shape.

4. The suction vibrator according to claim 3, wherein the deforming portion is formed into a wave shape.

5. The suction vibrator according to claim 4, wherein the driving handle has a diameter smaller than an inner diameter of the core tube.

6. The suction vibrator according to claim 5, wherein the main body vibrating portion extends in an angle with respect of the suction vibrating portion, and the main body vibrating portion comprises a vibration generator.

7. The suction vibrator according to claim 6, wherein the suction vibrator comprises a control panel, a power switch, a control button and a battery, the control panel comprises a control module respectively electrically connected with the power switch, the control button, the battery, the motor and the coil winding.
